(19) United States
(12) Patent Application Publication
(10) Pub. No.: US 2025/0060774 A1
(43) Pub. Date: Feb. 20, 2025

(54) PHOTONIC AND ELECTRONIC HAMILTONIAN MACHINES

(71) Applicant: Massachusetts Institute of Technology, Cambridge, MA (US)

(72) Inventors: Charles ROQUES-CARMES, Cambridge, MA (US); Marin SOLJACIC, Belmont, MA (US)

(73) Assignee: Massachusetts Institute of Technology, Cambridge, MA (US)

(21) Appl. No.: 18/722,121

(22) PCT Filed: Oct. 14, 2022
(86) PCT No.: PCT/US2022/078129

§ 371 Date: Jun. 20, 2024

Related U.S. Application Data
(60) Provisional application No. 63/291,754, filed on Dec. 20, 2021.

(51) Int. Cl. G06E 1/04

(52) U.S. Cl. CPC G06E 1/045

(57) ABSTRACT

Optical and electronic processors for calculating second-order and higher-order polynomials are described. A photonic processor can include an optical matrix multiplying unit OMMU that can perform vector-matrix multiplication. A portion of the inputs to the OMMU can be fed forward to combine with outputs from the OMMU when calculating polynomials. The described apparatus can also be used for probabilistic computing and polynomial combinatorial optimization.

### CROSS-REFERENCE TO RELATED APPLICATION

The present application claims a priority benefit, under 35 U.S.C. § 119 (e), to U.S. Application No. 63/291,754 filed on Dec. 20, 2021, titled “Photonic and Electronic Hamiltonian Machines,” which application is incorporated herein by reference in its entirety.

### GOVERNMENT SUPPORT

This invention was made with government support under W911NF-18-2-0048 awarded by the Army Research Office. The government has certain rights in the invention.

### BACKGROUND

Optical Ising machines have been proposed recently to calculate and find ground states of many-body Hamiltonians. Such machines can use the advantages of optical hardware, including high speed, low power consumption, and ease of parallelization. In particular, the rise of silicon photonics has enabled the realization of large-scale photonics hardware, with promising applications in implementing deep neural networks and solving large-scale combinatorial optimization problems.

Ising problems are of interest to physicists and computer scientists. The Ising Hamiltonian represents the many-body interaction of binary spins with quadratic couplings (i.e., only each of two spins can be coupled to each other) and encodes a great richness of physical phenomena, such as critical behavior, spontaneous symmetry breaking, and phase transitions. The Ising Hamiltonian is a textbook problem in statistical physics. It can model a variety of complex systems, from neural networks to spin glasses. In computer science, finding the ground state of the Ising problem is known to be NP-hard. Intuitively, this means that the computational complexity of finding the solution of a given instance of the Ising problem (a given set of couplings between spins) will scale exponentially in the problem size, denoted N. There also exist theorems that map the Ising problem to many other NP-complete problems in computer science, such as the traveling salesman problem and graph coloring. However, because of the quadratic nature of the Ising Hamiltonian, there can be a large polynomial overhead in calculating those mappings.

### SUMMARY

Photonic Hamiltonian machines (also referred to as “photonic second-order polynomial processors” or more succinctly as “photonic processors”) described herein exploit photonic hardware to solve Ising-like problems and higher-order polynomial Hamiltonians. Such photonic processors can calculate Ising Hamiltonians using homodyne detection. Some implementations of the photonic processors leverage the coherent nature of optical waves to interfere the output of a matrix multiplication unit with the original vector to calculate arbitrary second-order Hamiltonians. The photonic processor effectively operates as a second-order polynomial calculator and can be utilized to scale up optical computing hardware to higher-order polynomial calculators.

One example of a photonic processor calculates a second-order Hamiltonian H⁽²⁾(u|M) with a matrix M (which can be non-unitary) and an input vector u (which can be complex). This photonic processor includes an array of inputs, an optical matrix multiplication unit (e.g., comprising a network of Mach-Zehnder interferometers), and an array of photodetectors. In operation, the array of inputs receives a first array of optical signals modulated with the input vector u. The optical matrix multiplication unit, which is in optical communication with the array of inputs, generates a second array of optical signals from the first array of optical signals. The second array of optical signals represents a product Mu of the input vector u and the matrix M. And the array of photodetectors, which is in optical communication with the optical matrix multiplication unit, detects interference between the second array of optical signals and a third array of optical signals modulated with the input vector. This interference represents the second-order Hamiltonian H⁽²⁾(u|M).

The array of photodetectors can be a first array of photodetectors that converts the interference into first electrical signals, in which case the photonic processor can include second and third arrays of photodetectors and circuitry coupled to the first, second, and third arrays of photodetectors. The second array of photodetectors transduces a fourth array of signals modulated with the input vector u into second electrical signals. The third array of photodetectors, which is in optical communication with the optical matrix multiplication unit, transduces a fifth array of optical signals representing the product Mu of the input vector u and the matrix M into third electrical signals. And the circuitry produces an output proportional to the second-order Hamiltonian H⁽²⁾(u|M) from the first, second, and third electrical signals.

The photonic processor can also include a light source to generate the first array of optical signals and at least one modulator, in optical communication with the light source, to modulate the first array of optical signals with the input vector u.

The photonic processor can also include an array of probabilistic bits, in optical communication with the array of inputs, to generate the first array of optical signals as 1's with a controllable probability p and as 0's with a controllable probability 1−p.

Another example of the present technology is a method of calculating a second-order Hamiltonian H⁽²⁾(u|M) with a matrix M, which may be non-unitary, and an input vector u, which may be complex. This method includes generating a first array of optical signals modulated with the input vector u; generating, with an optical matrix multiplication unit, a second array of optical signals from the first array of optical signals, where the second array of optical signals represents a product Mu of the input vector u and the matrix M; and transducing interference between the second array of optical signals and a third array of optical signals modulated with the input vector u into an electrical signal, where the interference representing the second-order Hamiltonian H⁽²⁾(u|M).

The method may also include determining a reference signal proportional to a sum of |u|² and |Mu|² and subtracting the reference signal from the electrical signal to yield an output proportional to H⁽²⁾(u|M). It can include decomposing a k-order Hamilton into a plurality of (k−1)-order Hamiltonians. This plurality of second-order Hamiltonians includes the second-order Hamiltonian H⁽²⁾(u|M), where k is an integer greater than 2. Generating the first array of optical signals may include generating the first array of optical signals as 1's with a controllable probability p and as 0's with a controllable probability 1−p.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. Terminology explicitly employed herein that also may appear in any disclosure incorporated by reference should be accorded a meaning most consistent with the particular concepts disclosed herein.

### BRIEF DESCRIPTION OF DRAWINGS

The drawings are primarily for illustrative purposes and are not intended to limit the scope of the inventive subject matter. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A illustrates an example of a photonic second-order polynomial processor that can perform homodyne calculation of second-order Hamiltonians. Optical signals are fed to inputs of an optical matrix multiplication unit (OMMU). The optical signals are split and portions are routed to the other end of the OMMU. The output of the OMMU and the portions of the input optical signals are added coherently and then detected by an array of photodiodes (PD). The resulting electrical signals are added, and a reference signal (REF) is optionally subtracted from them. The resulting output is proportional to a second-order Hamiltonian function H(u).

FIG. 1B illustrates another implementation of a photonic second-order polynomial processor that can perform homodyne calculation of a second-order Hamiltonian with an arbitrary (e.g., non-unitary) matrix M and an arbitrary (e.g., complex) input vector u. In this photonic processor, the input and outputs are split to detect the amplitudes of the vectors |u| and |Mu|, respectively, which are then used as the reference signal REF.

FIG. 1C depicts a Mach-Zehnder interferometer that can be used to make the OMMU of FIG. 1A and FIG. 1B.

FIG. 1D depicts one example of optical interference devices connected together to form an OMMU of FIG. 1A and FIG. 1B.

FIG. 2A illustrates architecture for a higher-order photonic processor to calculate k-order polynomial functions (e.g., higher-order Hamiltonians) using multiple photonic second-order polynomial processors like those in FIG. 1A and FIG. 1B. H^{(k)}(u|M) is decomposed as a sum of N elements of the form H^{(k-1)}(u′|M′).

FIG. 2B illustrates all-optical summing with photonic hardware that can be used in the higher-order photonic processor of FIG. 2A. The inputs are xᵢ and yⱼ, and the output is Σᵢxᵢyᵢ. The depth of the binary tree is log₂ N.

FIG. 3A, FIG. 3B, and FIG. 3C are plots of time complexity scaling predictions for k= {2, 3, 4} (i.e., second-, third-, and fourth-order Hamiltonians), respectively.

FIG. 4A illustrates an implementation of a probabilistic photonic processor that performs probabilistic computing and polynomial combinatorial optimization. Signals from a set of optical probabilistic bit (p-bit) generators are fed to a photonic polynomial calculator (which may be implemented at least in part with the photonic processor depicted in FIG. 1A or FIG. 1B), equating the gradient of the cost function of interest with respect to the p-bit variable to be updated. The output of the photonic polynomial calculator is fed to one of the p-bit generators, defining its new probability parameter. The p-bits generators are updated asynchronously, so only one p-bit parameter is updated at a time.

FIG. 4B illustrates another implementation of a probabilistic photonic processor configured to update the p-bit parameters at the same time (synchronously vs. asynchronously as in FIG. 4A).

FIG. 4C illustrates another implementation of a probabilistic photonic processor that calculates an energy difference by clamping one p-bit to 0 (left) and then 1 (middle), and then calculating and providing the energy difference to update the probability parameter (right).

FIG. 5 depicts a free-space optical arrangement that can be used to implement at least part of a photonic processor or photonic calculator.

### DETAILED DESCRIPTION

Photonic processors can be configured to calculate and find ground states of many-body Hamiltonians and solve Ising-like problems. Such photonic processors can use the advantages of optical hardware, including high speed, low power consumption, and ease of parallelization. In particular, the technological advances of silicon photonics enable the realization of large-scale photonics hardware, with possible applications in implementing deep neural networks and solving large-scale combinatorial optimization problems.

Beyond simple Ising models, higher-order (orders greater than 2) Hamiltonians can model higher-order interactions and are therefore even harder to solve and model. Higher-order Hamiltonians also find applications in modeling more complex physical behaviors, such as protein folding and electronic structure calculations, and in achieving lower-order polynomial mappings with other NP-complete problems. Some formulations of NP-hard and NP-complete problems, such as integer factorization, are also encoded into higher-order polynomial Hamiltonians. Photonic processors described herein can be configured to solve higher-order Hamiltonians.

### 1. Optical Homodyne Calculation of Second-Order Hamiltonians

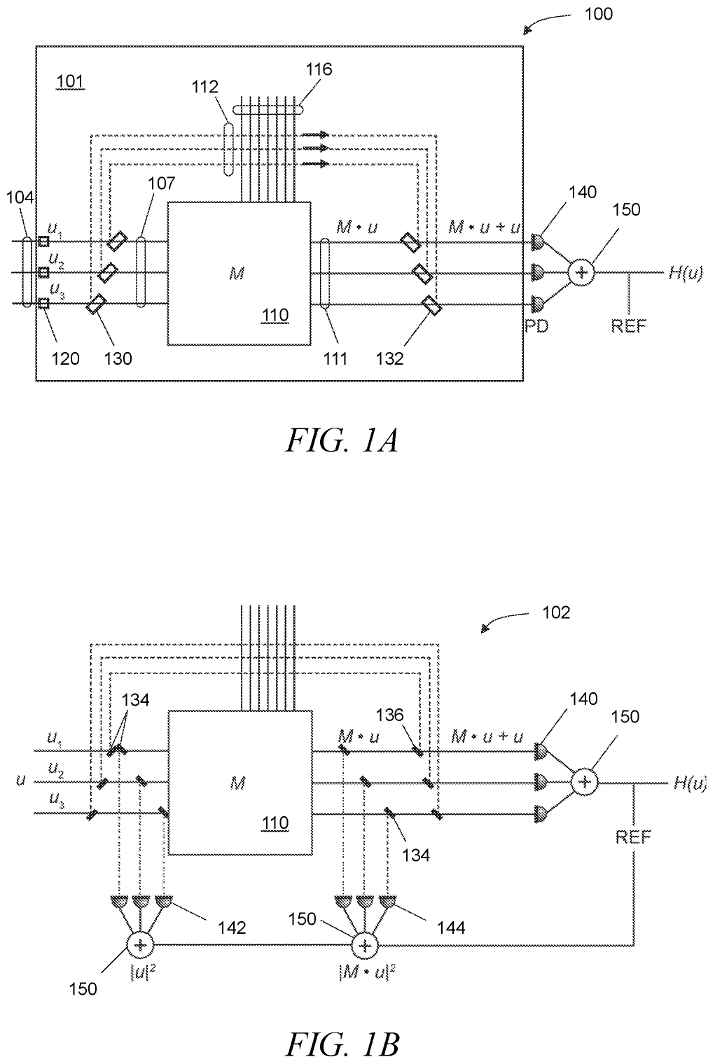

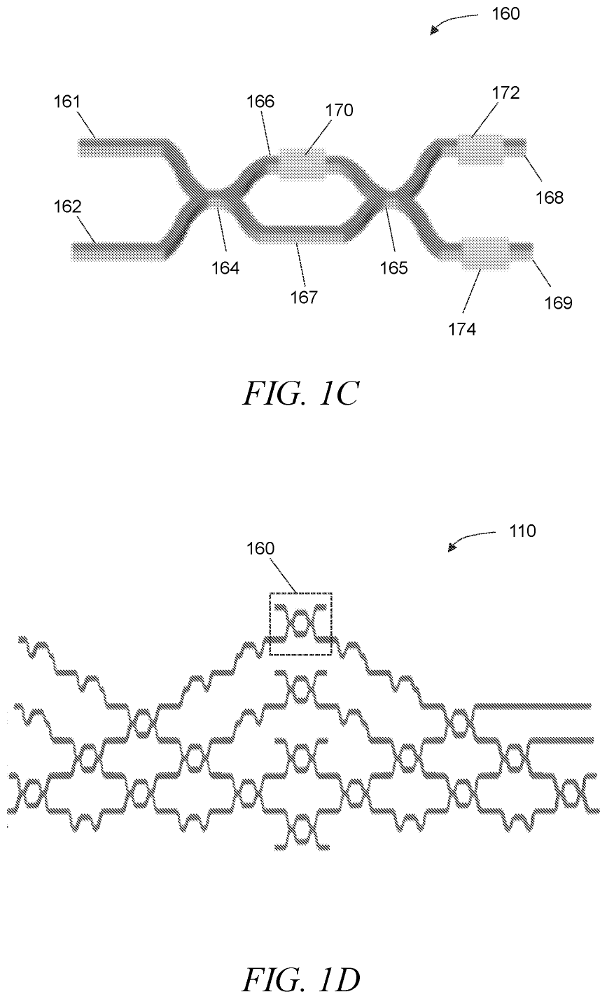

FIG. 1A and FIG. 1B depict example implementations of optical second-order polynomial processor 100 and 102, respectively, that can calculate second-order Hamiltonians applied to arbitrary input vectors u (as defined by Equation (1) below). The second-order polynomial processors 100, 102 each include a matrix multiplying unit 110, which is described in further detail below. In general, the calculation to be performed by the photonic processor 100, 102 can be written as:

$${H}^{( 2 )} ( u \vert M ) = {\sum }_{ij} {u}_{i} {M}_{ij} {u}_{j} \qquad ( 1 )$$

where M is an N×N matrix and u is a vector of size N. The calculation can compute energy of a system based on initial conditions of the system (e.g., based on a given configuration of spins, which can be represented by input vectors uᵢ). Such a calculation can be implemented as a vectorial calculation in the sense that the input state can be represented by the vector of {uᵢ}'s. Eq. 1 can be applied to systems that can be modeled using second-order Hamiltonians or second-order polynomials. Eq. 2, described below, can be applied to systems that can be modeled using higher-order Hamiltonians or higher-order polynomials.

For the photonic processor 100 of FIG. 1A, both the matrix M and the input vector u represent real values. However, the apparatus and methods can extend computations to complex-valued matrices and complex-valued vectors if the Hamiltonians of interest are of the form Re [H⁽²⁾(u|M)]. This extension follows from the complex wave nature of light.

For the implementations of FIG. 1A and FIG. 1B, the input vector u having components u₁, u₂, u₃ is encoded into an optical signal S (not shown). The encoding can be done by splitting the optical signal S into N signals to represent the vector components (u₁, u₂, u₃) of u. The N signals are provided to N input optical signal paths 104 that connect to the matrix multiplier's input signal paths 107 of the matrix multiplying unit 110. Encoding of the particular vector component values can be done using an array of optical modulators 120 (e.g., electro-optic or acousto-optic modulators) to modulate the signals provided to each of the N input signal paths 104. Typically, the amplitude of the optical signal on a signal path 104 is proportional to the value of the vector component that is represented on that signal path. Although the photonic second-order polynomial processors 100, 102 are shown with N=3 input signal paths 104, there can be fewer or more input signal paths depending on the desired second-order polynomial for which computation is to be performed.

The values that define the matrix M in Eq. 1 can also be encoded into optical domain. Encoding of M can be done by hardcoding and/or soft-coding properties of optical hardware that is used to implement the optical matrix multiplication unit (OMMU) 110. Example OMMUs are described below in connection with FIG. 1C and FIG. 1D. For instance, the values of the matrix M may be soft-coded into phase delays imparted by a plurality of phase shifters in the OMMU 110, such that the optical signals measured after the OMMU 110 on output signal paths 111 are proportional to the results of the vector-to-matrix multiplication Mu. Soft-coding of phase delays means that the OMMU 110 can be reconfigured by changing the phase delays on internal optical components (e.g., to encode values for a different matrix M corresponding to a different second-order polynomial or Hamiltonian). Soft-coding and reconfiguring of the matrix M may be done by applying signals over control inputs 116 to set phase-shift values on internal phase shifters of the OMMU 110.

For the photonic processor 100 of FIG. 1A, the outputs from the OMMU 110 on output optical paths 111 are added coherently with feedforward signals from feedforward optical paths 112. The feedforward signals can be derived from the input vector components u₁, u₂, u₃, by splitting off a portion (e.g., 50% or a value between 5% and 95%) of the input vector components with an array of optical splitters 130, for example. An optical splitter 130 can be a beam splitter, a fiber-optic splitter, an integrated waveguide splitter (such as a Y-junction splitter), etc. Coherent addition of feedforward signals with the output signals from the OMMU 110 can be performed with optical combiners 132, which can be beam splitters, fiber-optic couplers, or integrated waveguide combiners (such as Y-junction combiners), etc. The optical splitters 130 and optical combiners 132 can couple a portion of the input signal from each channel before the OMMU 110 to the same channel after the OMMU 110. The coherent addition can comprise optical interference of the output signals from the OMMU 110 and the feedforward signals. The resulting optical interference can be detected by an array of photodiodes 140. The resulting electrical signals are added by an electronic summing circuit 150 (which may add the voltages or currents from each photodiode 140 into a summed signal). An example summing circuit can be a summing operational amplifier circuit that is configured as a voltage adder.

In some implementations, an optional reference signal (REF) can be subtracted from the summed signal that is output from the summing circuit 150. In FIG. 1A, the signal from the summing circuit 150 is proportional to |Mu+u|²=2|u|²+2H⁽²⁾(u|M)=2N+2H⁽²⁾(u|M), which is simplified based on the facts that M is unitary and that uᵢ²=1 for all i. Therefore, by subtracting a constant reference signal REF, the final output of this architecture can be made directly proportional to H⁽²⁾(u|M). REF can be determined as the constant output voltage when varying the value of the input vector u (or, equivalently, the output voltage when H⁽²⁾(u|M)=0. In some implementations, the summing circuit 150 can be further configured to subtract the reference signal REF from the sum of the photodiodes' electronic outputs.

According to some implementations, the photonic processor 100, 102 can be implemented with integrated optical components formed on a substrate 101 (e.g., a semiconductor substrate). The modulators 120 may or may not be formed on the same substrate as the OMMU 110. The N input optical signal paths 104 and the feedforward optical paths 112 can be implemented as integrated optical waveguides. The photodetectors 140 may or may not be formed on the same substrate 101 as the OMMU 110.

FIG. 1A and FIG. 1B show different optical second-order polynomial processors 100, 102 that can be used to calculate H⁽²⁾(u|M). The optical architecture in FIG. 1A is adapted to the case where M is a unitary matrix and the input vector u encodes a binary vector with values #1. This case can correspond to a unitary Ising model, depending on the choice of M.

FIG. 1B shows an optical architecture that can calculate H⁽²⁾(u|M) for arbitrary matrices M and vectors u. The general setup includes an OMMU 110, optical splitters 134 at each optical splitting location (also indicated by dashed lines divided off of solid lines), optical combiners 136 at each optical combining location, and photodetectors 140 as used in the architecture in FIG. 1A. These devices produce a detected signal proportional to |Mu+u|² after the summing circuit 150, as done for the photonic processor 100 of FIG. 1A. The optical architecture in FIG. 1B also includes two more beam splitters per channel. These beam splitters couple optical signals to two (linear) arrays of photodiodes (a first array of photodiodes 142 before the OMMU 110 and a second array of photodiodes 144 after the OMMU 110), which record electronic signals proportional to |u|² and |Mu|², respectively, which are summed by summing circuits 150 to form an electrical domain reference signal REF. In FIG. 1B, a REF signal proportional to |u|²+|Mu|² is used to remove a bias signal from the output. In the absence of the simplifying assumptions from FIG. 1A, the electrical signal measured by the output array of photodiodes 140 for the photonic processor 102 of FIG. 1B is proportional to |αMu+βu|²=α²|u|²+β²|Mu|²+2αβH⁽²⁾(u|M). Therefore, by appropriately weighting the signal detected from the detection of |u|² and |Mu|², one can subtract REF from the detected signal (proportional to |Mu+u|²) such that the final output is proportional to H⁽²⁾(u|M).

FIG. 1C depicts an example of an optical interference device 160 that can be used to make the OMMU 110 described above. The interference device 160 comprises a Mach-Zehnder interferometer (MZI) having two input ports 161, 162, two multimode interference couplers, 164, 165, two interferometer arms 166, 167 and two output ports 168, 169. There can be at least one phase shifter 170 coupled to at least one interferometer arm 166 of the MZI and at least one phase shifter 172 on at least one of the output ports 168. In some cases, there can be at least one phase shifter coupled to at least one input port 161, 162 to the MZI instead of, or in addition to, one or more phase shifters coupled to the output port(s) of the MZI. The phase shifters 170, 172, 174 can be based on thermal effect (e.g., using integrated heaters), plasma dispersion effect (e.g., carrier injection), or the electro-optic Pockels effect (e.g., applied voltage) to induce changes in the waveguide's refractive index and alter the phase of an optical signal propagating in the waveguide to which the phase shifter is coupled. A phase change imparted in an interferometer arm 164, 165 can change the relative amplitudes of power output from the output ports 168, 169 from the MZI.

To construct an OMMU 110, the optical interference devices 160 of FIG. 1C can be connected together in a network. FIG. 1D depicts one example of a network of optical interference devices 160 connected together to form an OMMU 110. The phase shifters 170, 172, 174 (not shown to simplify the drawing) would be connected to control lines running to control inputs 116 (not shown to simplify the drawing).

The time and spatial complexity of optical processors 100, 102 like those in FIG. 1A and FIG. 1B can be evaluated to compare their performances with all-electronic counterparts. For such an evaluation, it is assumed that a single vector-to-matrix multiply using the OMMU 110 has the following time complexity: τ_{OMMU}(N). In the case of an OMMU 110 with a triangular array of MZIs (such as that shown in FIG. 1D), τ_{OMMU}(N)=O(N), where the Landau notations O(N) and o(N) are used to compare orders of magnitude. In the Landau notations, f(N)=O(g(N)) means that f(N)/g(N) is bounded for large enough N; f(N)=o(g(N)) means that f(N)/g(N)→0 when N→∞). Those can be understood as follows. First, the time complexity is proportional to the time light takes to propagate through the MZI array in the OMMU. This propagation time can be approximated by ˜N_{MZI}*L_{MZI}/c, where N_{MZI} is the number of MZIs in the optical path and each MZI has an optical path length of L_{MZI}. Typically, N_{MZI}˜N and L_{MZI}˜50 μm. Second, the spatial complexity is proportional to the square of the number of matrix elements N² in the most general case.

The additional components (optical splitters, optical combiners, photodetectors) of the systems in FIG. 1A and FIG. 1B generally do not add any significant time complexity to the system. Specifically, each optical splitter 130, optical combiner 132, and detection event (by the photodetectors 140) has O(1) complexity because the photonic processor leverages the parallelization of one vector u over N channels. The addition of the photodetector outputs can be performed in log₂ N complexity, where log₂ is the logarithmic base 2, which is much smaller than O(N) and therefore negligible in complexity analysis. Therefore, the total time complexity of calculating H⁽²⁾(u|M) for a given input vector u and matrix M is O(N). The time taken to (re-)configure the OMMU 110 to implement matrix M is denoted τ_{M}(N) and depends at least in part on the size of the matrix M.

To benchmark the performance of the architecture, the calculated time complexity is compared to that of a sequential implementation (as can be implemented on electronic hardware). Since the sequential implementation performs the summation of every N² in the Hamiltonian, the total time complexity for the sequential implementation in electronic hardware is on the order of τₑ=τ_{MAC}N²=O(N²).

There are two regimes of operation and applications where photonic architectures like those in FIG. 1A and FIG. 1B offer an advantage over electronic hardware:
(1) If τ_{M}(N)=O(N), then the photonic architecture is faster than the electronic one for larger N (e.g., N>100), even if each calculation involves a reconfiguration of the OMMU 110 (which would result in a time complexity O(N²), still faster than the electronic architecture).
(2) If τ_{M}(N)>O(N) or worse, the photonic architecture is superior to the electronic one if the OMMU is not reconfigured or if it is reconfigured every ˜τ_{M}(N)/N matrix multiplications or less. This case is especially attractive for situations where one or few fixed matrices are of interest, and where the input vector is reconfigured. Heuristically, this corresponds to calculating H⁽²⁾(u|M) for many input vectors u's but for a few fixed matrices M's.

### 2. Power Iteration to Calculate Matrix Eigenvalues

The optical processors 100, 102 in FIG. 1A and FIG. 1B can also be used for calculating the largest eigenvalue of arbitrary matrices by power iteration. The photonic processors shown in FIG. 1A and FIG. 1B exhibit a superior advantage in time complexity when the calculated matrix is rarely reconfigured, as discussed immediately above. One application in which the matrix is rarely reconfigured is the process of power iteration to calculate the largest eigenvalue(s) of a known matrix.

Power iteration can be performed with versions of the optical processors 100, 102 shown in FIG. 1A and FIG. 1B where the output of the OMMU 110 is interfered with vector components output from a reference local oscillator (not shown). Each vector component of the local oscillator has a known or user-selected amplitude and phase. These vector components from the local oscillator are used to reconstruct components of the input vector u. Using a local oscillator allows one to measure directly the vector-matrix product Mu at the output of the photodiodes 140. The dominant eigenvalue (eigenvalue with largest absolute value) can be found by starting from a random initial vector u₀ and iterating over vector-to-matrix multiplications νₖ₊₁=Muₖ. The next vector uₖ₊₁ input for each iteration should be normalized at each step: uₖ₊₁=νₖ₊₁/∥νₖ₊₁∥. This process, known as power iteration or the Von Mises iteration, converges to the dominant eigenvector of M (where the dominant eigenvalue A can be identified as Mu_{∞}=λu_{∞}). (The conditions for convergence are that the dominant eigenvalue has an absolute value strictly larger than all other eigenvalues, and that the initial state has a non-zero component along the direction of u_{∞}.)

3. Calculating Higher-Order Polynomials and Hamiltonians with Photonics

The previous techniques and photonic processors 100, 102 used to calculate second-order polynomials (such as a second-order Hamiltonian) can be extended to the calculation of higher-order Hamiltonians of the form:

$${H}^{( k )} ( u \vert M ) = {\sum }_{{i}_{1} … {i}_{k}} {M}_{{i}_{1} … {i}_{k}} {u}_{{i}_{1}} … {u}_{{i}_{k}} , \qquad ( 2 )$$

where M is a k-th order tensor (the methods discuss below can be generalized to a sum of several higher-order Hamiltonians of the form ΣₖH^{(k)}(u|M^{(k)}) by summing outputs from each tensor). Any smooth function can be Taylor-expanded around a point of interest into a polynomial function. Therefore, these techniques can be used to calculate approximations of arbitrary functions by calculating their Taylor series truncated at a certain order.

A higher-order Hamiltonian can encode higher-order interactions between elements of the vector u (size N). A single term Hamiltonian illustrates this concept: take a simple Hamiltonian of the form −uᵢ_{₁} . . . uᵢ_{ₖ} with degrees of freedom for the vector uᵢ=±1. The case k=2 is that of a ferromagnet, such that ground state energies are achieved for spins that are aligned u₁=u₂=±1. The case k=3 can result in configurations that are non-trivial, such that ground state energies are achieved for spins that are aligned u₁=u₂=u₃=±1, but also for configurations where any two spins are aligned, with the third spin being in an up state: e.g., (u₁, u₂, u₃)=(−1, −1, +1). Therefore, such Hamiltonians can encode more complicated physics, but also higher-order constraints in optimization problems.

A polynomial function of order k can be rewritten as the sum of N polynomial functions of order (k−1):

$${H}^{( k )} ( u \vert M ) = {\sum }_{{i}_{1}} {u}_{{i}_{1}} {\sum }_{{i}_{2} … {i}_{k}} {M}_{{i}_{2} … {i}_{k}} {u}_{{i}_{2}} … {u}_{{i}_{k}} = {\sum }_{{i}_{1}} {u}_{{i}_{1}} {H}^{( k - 1 )} ( {u}^{′} \vert {M}_{{i}_{1}}^{′} ) , \qquad ( 3 )$$

with H^{(k-1)}(u′|M′ᵢ_{₁})=Σᵢ_{₂}_{. . . i}_{ₖ} Mᵢ_{₂} _{. . . i}_{ₖ} uᵢ_{ₖ} . . . uᵢ_{ₖ} and where u′ is a reduced vector of dimensionality N−1 (equating u on a subspace) and M′ a tensor of order (k−1).

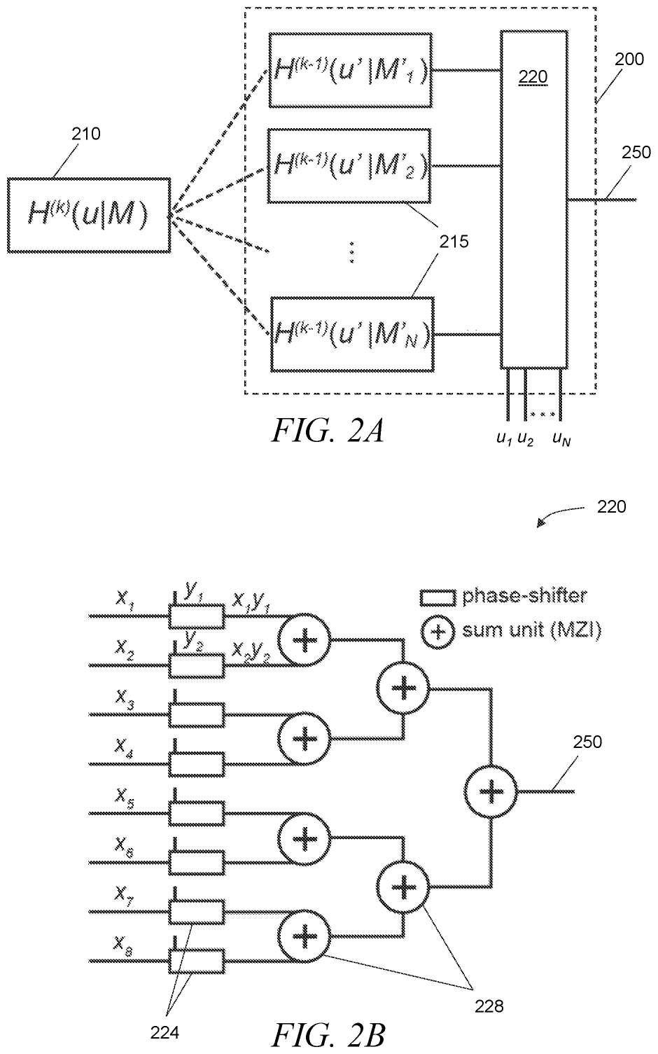

FIG. 2A shows a higher-order polynomial optical processor 200 that can be used to calculate polynomials of order greater than 2^{nd} order. A polynomial function 210 of order k can be decomposed as the sum of N polynomial functions of order (k−1), in accordance with EQ. 3. This process can be carried out in two steps:
(1) For i₁=1, . . . , N, calculate and store H^{(k-1)}(u′|M′ᵢ_{₁}); and
(2) Calculate the sum Σᵢ_{₁}uᵢ_{₁}H^{(k-1)}(u′|M′ᵢ_{₁}).

Step (1) can be performed recursively until k=2, whereupon an optical processor 100, 102 of FIG. 1A and FIG. 1B can be utilized. For example, if k=3 in FIG. 2A, then N optical sub-processors 215 (equivalent to the photonic processors 100, 102) can be used for the N, k−1=2 polynomials and the outputs from each optical sub-processor 215 can be multiplied with appropriate values and summed together with a multiplying and summing circuit 220. The multiplying and summing circuit 220 may sum outputs from the optical sub-processors 215 (multiplied by the values uᵢ, according to step (2)) electronically (signals taken after the photodiodes 140) or may alternatively multiply and sum outputs optically (signals taken before or after the photodiodes 140). If the signals from the optical sub-processors 215 are taken after the photodiodes 140, they can be converted to an optical signal for an all-optical multiplying and summing circuit 220.

Step (2) may be performed optically, at least in part, though its complexity is on the order of log₂ N. An example of an all-optical multiplying and summing circuit 220 is depicted in FIG. 2B. The electrical signals from the optical sub-processors 215 are taken after the photodiodes 140 and converted to optical signals for the multiplying and summing circuit 220 of FIG. 2B. The outputs from the optical sub-processors 215 can be provided as the xᵢ inputs to the multiplying and summing circuit 220. The values uᵢ can be provided as the yᵢ inputs to the multiplying and summing circuit 220. In the illustrated embodiment, multiplication by the uᵢ values is implemented as phase shifts (by phase shifters 224) on the optical signals xᵢ. The phase shifters 224 are shown with two inputs: an optical input representative of xᵢ, and an electronic input to set a phase representative of yᵢ. Summing is performed coherently using coherent combiners 228 (e.g., MZIs). The coherent combiners 228 can connect to one or two phase shifters 224. Outputs of coherent combiners 228 can connect to additional coherent combiners until all multiplication products xᵢyᵢ are summed to provide an output 250 from the higher-order polynomial photonic processor 200. For the example of FIG. 2B, N=8 but the invention is not limited to only this value. The value of N can be determined, for example, by the number of spins of a system or the number of components of the input vector u. N>0 can have odd integer values or even integer values and can be determined by the size of M.

For some implementations, the optical hardware used to calculate a polynomial or Hamiltonian of any order k can be constructed as the composition of N complete optical sub-processors 215 of order k−1 (combined together as in FIG. 2A). This represents a decomposition of a higher-order Hamiltonian into lower-order Hamiltonians. In turn, each optical sub-processor can be constructed as the composition of N complete optical sub-processors of order k−2 and so on until the order of the optical sub-processor is 2^{nd} order, in which case the photonic processor 100, 102 of FIG. 1A or FIG. 1B can be implemented for hardware as described above. Composition, in this context means the assembly of optical sub-processors 215 (such as sub-processors implemented as photonic processors 100, 102), multiplying and summing circuits 220, connecting waveguides, and electronic circuitry (e.g., to implement phase shifts, to sum outputs of photodiodes, to convert electrical to optical signals, etc.). Implementing N copies of photonic processors 100, 102 for higher order polynomials can result in a larger spatial footprint for the higher-order polynomial photonic processor 200. Alternatively, the composition of a higher-order polynomial photonic processor 200 can be performed in time domain, so that a single piece of optical hardware to calculate polynomials of order (k−1) can be utilized to calculate polynomials of order k by time-multiplexing different configurations of the function H^{(k-1)}(u′|M′ᵢ_{₁}). In such an implementation, outputs from the optical hardware would be stored and provided to a subsequent computation as the calculations proceeds from the computations for the 2nd order polynomial sub-processors 100, 102 to the kth-order polynomial.

### 4. Complexity Estimation

There is a recurrence relationship between complexities for calculating a polynomial function of order k with photonic hardware:

$${C}_{k + 1} ( N ) = {NC}_{k} ( N ) + {τ}_{\sum } {log}_{2} N . \qquad ( 4 )$$

Consider the specific case of a network of MZIs as the photonic hardware to calculate vector-to-matrix multiplications (corresponding to second-order polynomial equation utilizing the setup shown in FIG. 1A or FIG. 1B). Then, we can get the complexity of calculating a polynomial function of order k over N spins, represented by an input vector having N components. The second-order complexity is C₂(N)=Nτₒₚₜ+τ_{M}(N)+τ_{Σ} log₂ N: a linear complexity coming from the MZI architecture, a constant term corresponding to the cost of reconfiguring the MZI array for a given matrix, and a logarithmic term for the addition. The resulting complexity of the k-th order polynomial calculation is

$${C}_{k} ( N ) = {N}^{k - 2} ( N {τ}_{opt} + {τ}_{M} ( N ) ) + {τ}_{\sum } {log}_{2} N \frac{{N}^{k - 1} - 1}{N - 1} .$$

As a result, Cₖ(N)=O(N^{k-2} (Nτₒₚₜ+τ_{M}(N))). As a comparison, the expected complexity from a sequential (counterpart electronic) implementation is Cₖ(N)=O(N^{k}).

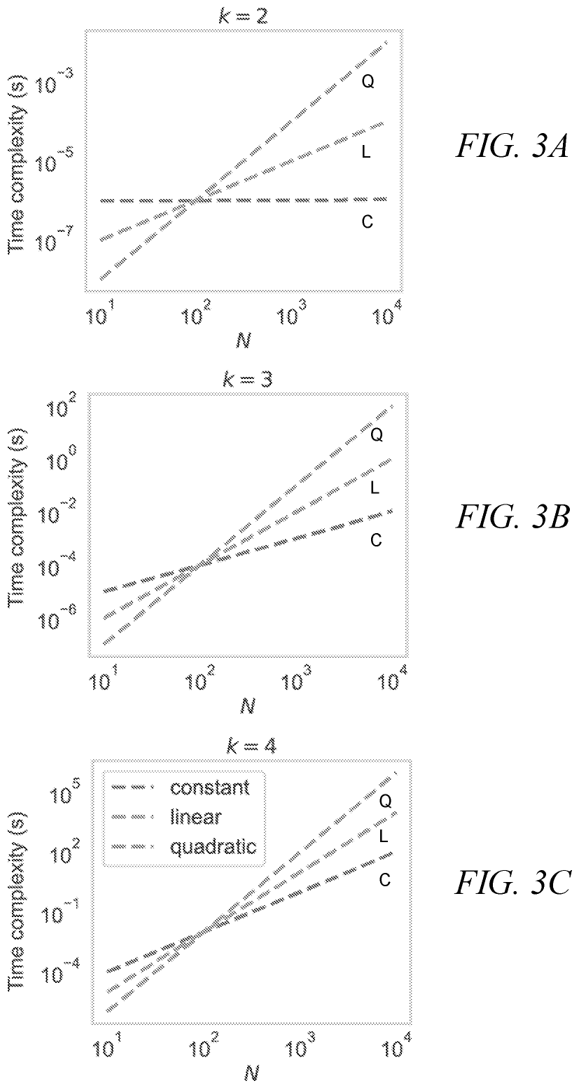

FIG. 3A, FIG. 3B, and FIG. 3C are plots of the corresponding complexity for a photonic processor implementation as a function of N for various k={2, 3, 4}. Overall, the photonic processor implementation is more efficient for large N if τ_{M}(N) is faster than quadratic complexity. For each plot, τₒₚₜ=τ_{Σ}=10⁻¹¹s. Each plot shows traces for τ_{M}(N) being constant (C), linear (L), or quadratic (Q) in N, such that τ_{M}(100)=10⁻⁶s.

### 5. Applications to Probabilistic Computing and Polynomial Combinatorial Optimization

The methods described above can be applied to implementing polynomial combinatorial optimization when coupled to probabilistic computing techniques. Apparatus for such implementations can use a probabilistic bit (p-bit) generator or source, which is a device which can generate (uncorrelated) samples from a tunable Bernoulli distribution. This means that the output of the p-bit generator equals 0 with probability 1−p and equals 1 with probability p, where p can be controlled (e.g., optically or electronically). A p-bit can be generated optically, electronically, or opto-electronically (e.g., by generating random numbers with a computer controlling the input of the photonic system that outputs an optical signal for the p-bit). Since combinatorial optimization involves the repeated evaluation of a polynomial cost function H^{(k)}(u|M), we can utilize the methods described above to accelerate the computation.

For instance, a p-bit source could be implemented electronically as a computer programmed to output values according to a tunable Bernoulli distribution. Given a generator Y (with outcome y) of random numbers of a uniform distribution in [0, 1], the computer can generate a p-bit as X such that the outcome x of X is x=0 if y>p or x=1 if y<p. Generators like Y can be found in or produced using most random number libraries, such as the “rand” number generator in a MATLAB random number generator library.

Alternatively, a p-bit generator can be implemented using a stochastic electronic system, such as a magnetic tunnel junction, configured to oscillate between two steady states that are mapped to 0 and 1 outcomes (see, e.g., Borders, W. A., Pervaiz, A. Z., Fukami, S., Camsari, K. Y., Ohno, H., & Datta, S. (2019). Integer factorization using stochastic magnetic tunnel junctions. Nature, 573(7774), 390-393, which is incorporated herein by reference in its entirety). In such systems, the probability p can be tuned by adjusting a bias voltage that drives the system towards one specific state.

To turn the output of an electronic p-bit generator into an optical signal, one can for instance use the p-bit output to control a phase shifter modulating an optical signal.

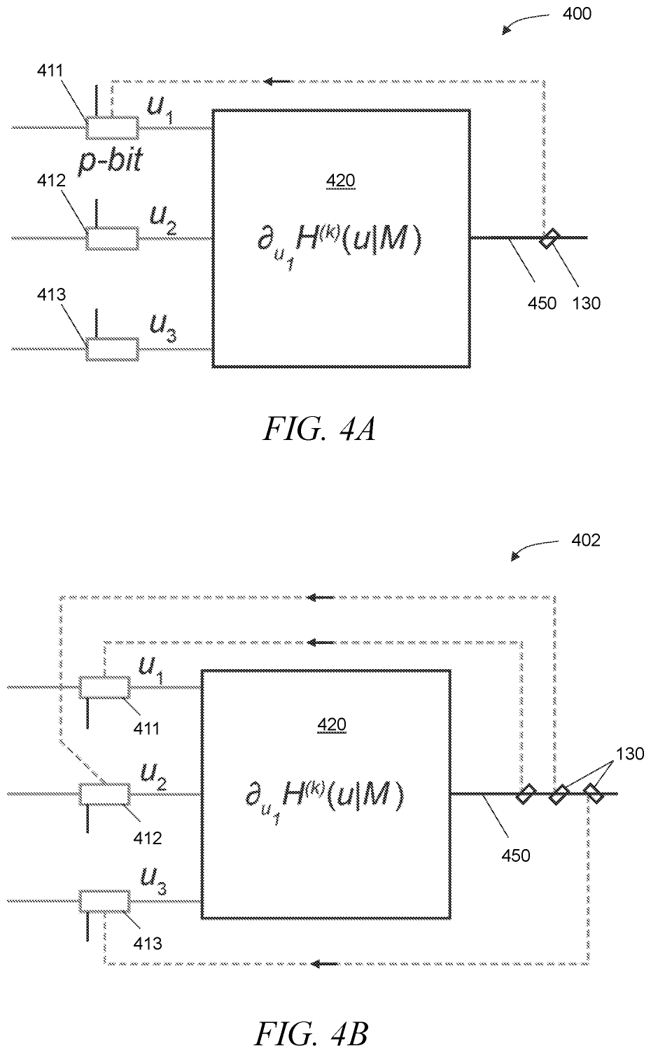

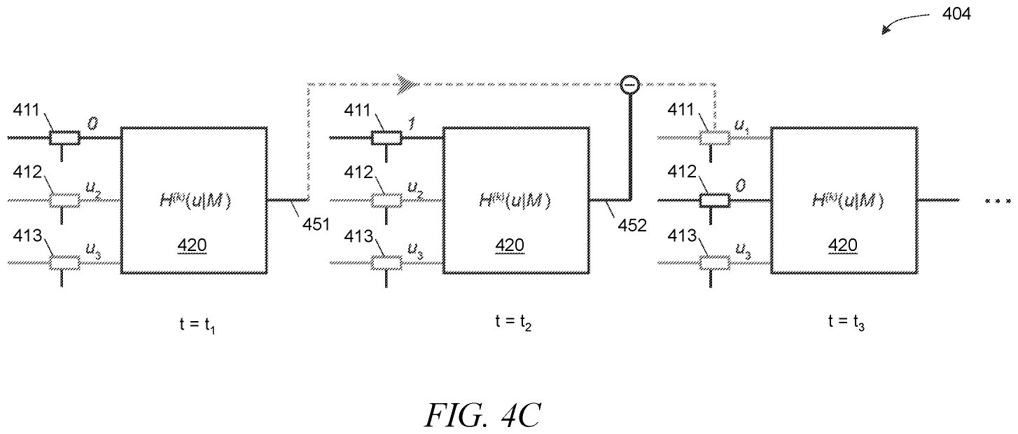

FIG. 4A, FIG. 4B, and FIG. 4C illustrate several probabilistic photonic processors 400, 402, and 404, respectively, to accelerate polynomial combinatorial optimization using at least one photonic processor (of second order or higher order as described above). In FIG. 4A, the probabilistic photonic processor 400 includes a set of optical p-bit generators 411, 412, 413 which feed signals to a photonic polynomial calculator 420 (e.g., implemented at least in part as an appropriately programmed photonic processor 100, 102, 200 as described above). The p-bit generators 411, 412, 413 can be implemented, at least in part, as phase shifters that impart random phase values to input optical signals, for example. The photonic polynomial calculator 420 is configured to equate the gradient of the cost function of interest with respect to the p-bit variable to be updated. A portion of the output 450 of the photonic polynomial calculator 420 is fed back to one of the p-bit generators 411 with an optical splitter 130 as indicated by the dashed line in FIG. 4A, defining that p-bit generator's new probability parameter. Optical-to-electronic conversion (e.g., with a photodiode) may be performed on the feedback signal at the p-bit generator 411 and the resulting electronic signal summed with a random signal (e.g., an electronic signal from a computer) to set the amount of phase shift by the p-bit generator 411). The p-bit generators 411, 412, 413 can be updated asynchronously, with one p-bit parameter updated at a time. The p-bit generators can each have two inputs. A first input receives a seed value to produce a random output p-bit value. The second input receives a tunability parameter that allows tuning (scaling and/or offsetting) the output p-bit value. To fix the output p-bit value, the two inputs can be held at constant values. Although the implementation of FIG. 4A has three optical inputs, there can be fewer or more depending on the number of vector components uᵢ.

FIG. 4B depicts a probabilistic photonic processor 402 having three p-bit generators 411, 412, and 413 feeding a photonic polynomial calculator 420 with synchronous p-bit updates. The photonic polynomial calculator 420 is configured to equate the gradient of the cost function of interest with respect to the p-bit variable to be updated. One or more optical splitters 130 at the output 450 of the photonic polynomial calculator 420 feed portions of the output back to each p-bit generator 411, 412, 413, updating the p-bit parameters at the same time.

The p-bit parameter updates can be performed either asynchronously as in FIG. 4A or synchronously as in FIG. 4B. The asynchronous method converges to the stationary distribution of interest exp−βH^{(k)} with β the steepness of the p-bit parametrization. However, the synchronous method can explore new states at a faster rate, by potentially updating every single p-bit at each step. In addition, the p-bit updates can be performed all-optically or opto-electronically depending on the type of p-bit generator and the way the p-bit's Bernoulli parameter is controlled (either electronically or optically). The feedback control informs the state of the p-bit at the next step of the process.

FIG. 4C illustrates how at least one photonic polynomial calculator 420 can calculate the energy difference by clamping one p-bit to 0 and 1, and then calculating the energy difference to update that p-bit source's probability parameter. More specifically, FIG. 4C shows the p-bit generators, p-bits, and photonic polynomial calculator 420 at three different time steps (t=t₁, t=t₂, and =t₃). During the first time step (t₁), the p-bit generator 411 of interest clamps its bit to 0 (clamping of the p-bit value is indicated by a dark-shaded p-bit generator 411), causing the photonic polynomial calculator 420 to produce a first output 451. During the second time step (t=t₂), the p-bit generator 411 of interest clamps its bit value to 1, causing the photonic polynomial calculator 420 to produce a second output 452. The difference between the first output 451 and second output 452 is computed (H^{(k)}(u|M; uᵢ=1)−H^{(k)}(u|M; uᵢ=0)) and this difference is fed into the p-bit generator 411 during the third time step (right=t₃). At time t=t₃ in FIG. 4C, the second p-bit generator 412 clamps its bit value to 0 during the third time step to represent that this process of clamping p-bit values and providing the difference of outputs 451, 452 from two time steps is iterated for each p-bit generator 411, 412, 413. In some implementations, a plurality of photonic polynomial calculators 420 (e.g., three or more) can be connected together as shown in FIG. 4A through FIG. 4C to perform the three-step calculations described above more rapidly for one or more p-bit generators instead of using a single photonic polynomial calculator 420 for each time step and reconfiguring the calculator's p-bit generator with each time step. As with FIG. 4A and FIG. 4B, there can be fewer or more than three inputs to the photonic polynomial calculator 420 and hence, fewer or more than three p-bit generators coupled to the inputs.

### 6. Photonic and Optoelectronic Implementations of Optical Polynomial Processors

The photonic processors, OMMUs, and photonic polynomial calculators described above can be implemented in several different ways. The photonic processors and calculators described above include at least one OMMU. Most photonic architectures that implement OMMUs 110 exploit high degrees of spatial multiplexing to reduce the time complexity of vector-to-matrix multiplications from O(N²) to O(N) or O(1).

For example, an OMMU 110 can be implemented as a triangular or square array of MZIs arranged to perform matrix multiplications. The array of MZIs can be combined in an optical network with phase-shifters (at least one per MZI) to emulate general complex matrices, by leveraging their eigenvalue decomposition. In these implementations, a single MZI can mix optical signals from two optical channels (e.g., two input waveguides). The network of MZIs can be arranged to mix N channels (as in the example of FIG. 1D), emulating a unitary matrix. The components of the matrix can be encoded using phase shifts imparted by one or more phase shifters 170, 172, 174 at one or more MZIs in the network. This architecture for an OMMU 110 relies on the fact that a unitary matrix can be decomposed into a product of unitary matrices acting only on two separate channels.

There are several possible integrated/chip architectures that can leverage the use of MZI networks to implement OMMUs 110 like those described in FIG. 1A and FIG. 1B. To start, the vector-to-matrix multiplication can be performed by an optical network of MZIs, as described above. The state preparation of input vector components u₁, u₂, . . . u_{N} can be performed by splitting coherent light (e.g., coming from a laser) into multiple inputs (each corresponding to an input channel for the optical network of MZIs), coupling the light into each input channel (e.g., optical waveguide), and then modulating the optical signals in one or more channels separately with an array of optical modulators 120 (e.g., phase shifters). The input splitting can be realized with integrated or free-space optical splitters. The routing of the inputs to the output of the photonic processors and calculators for interference as described above, in connection with FIG. 1A, FIG. 1B, FIG. 1D, FIG. 2A, FIG. 2B, and FIG. 4A through FIG. 4C can be realized with waveguides arranged on a photonic chip (e.g., a predominantly 2D planar layout on the chip) with delay compensation implemented by optical delay lines (e.g., optical waveguide path length for pulsed operation) or phase-shifters coupled to optical waveguides (for continuous operation). In some cases, a photonic processor or photonic calculator described above can be realized by utilizing 3D or 2.5D interconnects to route optical signals to and from at least one other layer of the chip. For example, the components of the OMMU 110 can be formed on a single layer or divided among two or more layers of the chip. The optical modulators 120 and/or p-bit generators 411, 412, 413 can be formed on a same layer as the OMMU 110 or on one or more different layers.

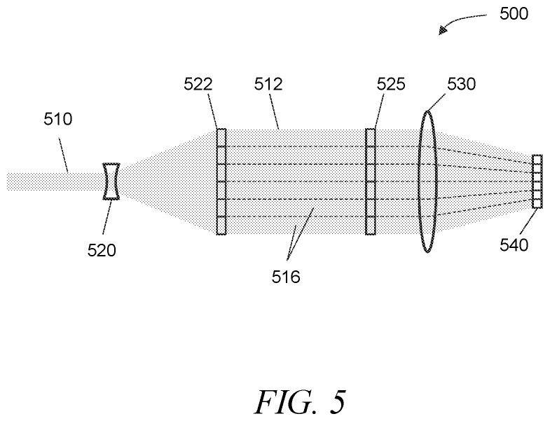

A photonic processor or photonic calculator described above including an OMMU 110 can also be implemented as a set of free-space optical components illuminated by coherent light. For some implementations, the optical components can include, but are not limited to, lenses and spatial light modulators. FIG. 5 depicts an optical arrangement 500 that can be used to implement, at least in part, an OMMU 110 of FIG. 1A and FIG. 1B. For example, a spatially and temporally coherent optical beam 510 from a laser having a narrow linewidth (e.g., less than 5 nm) can illuminate a diverging lens 520 (acting as a demultiplexer or optical splitter) to spread the beam into a larger beam 512 that can be divided into beamlets 516 acting as input channels to the OMMU. A first spatial light modulator (SLM) 522 can spatially modulate separate beamlets 516 from the larger beam 512 to perform state preparation of inputs to the OMMU. A second SLM 525 can encode the matrix weights, and a converging lens focuses light back into a detector array. Homodyne detection by mixing the output with the input state can be realized with optical splitters and optical combiners to measure the output phase for each beamlet 516.

Alternatively, a photonic processor or photonic calculator described above can be implemented with a hybrid free-space/integrated optical architecture, taking components from the integrated MZI and free-space architectures, where, for instance, the optical state preparation can be performed in an integrated platform (e.g., with integrated thermo-optic phase shifters), while the matrix multiplication is performed in free-space (e.g., with a spatial light modulator).

A free-space photonic processor or photonic calculator described above can also be configured to operate with incoherent light instead of coherent light. In some cases, the optical setup can be similar to that for coherent signal processing with free-space components (e.g., using bulk lenses, SLMs, optical splitters, etc.) except each row of the matrix mask is split into two (one for positive, one for negative values), and projected into different locations on the detectors, which are then electrically connected in opposition, with one being at a positive voltage and the other being at a negative voltage (to consider the sign difference).

Other suitable implementations include apparatus using diffractive optical neural networks and apparatus using electronic hardware such as field-programmable gate arrays (FPGAs). In a diffractive optical neural network, the optical system is designed such that illuminating a mask with coherent light results in a linear transformation parametrized by the complex transmission of the diffractive mask. In an electronic system that uses an FPGA, the matrix weight data are transmitted and written to memories on the FPGA using static random access memory (SRAM) or block random access memory (BRAM). The FPGA leverages N parallel channels to calculate the matrix with complexity linear in N.

The optical and electronic processors, calculators, and processes disclosed here can be applied to at least the following problems in combinatorial optimization and computer science:
Finding the ground state of and sampling Ising problems;
Solving MAX-CUT problems;
More generally, solving NP-hard and NP-complete problems that can be mapped to the Ising problem;
Integer factorization problems;
Protein folding problems;
Eigenvalue solver via power iteration; and
Generation and inference of proof of work for blockchain-based technology mining (such as cryptocurrencies).

Photonic and electronic Hamiltonian machines can be implemented and/or included in optical systems in various configurations. Example configurations are listed below.

Corresponding methods of using the Hamiltonian machines and operating the optical systems can also be implemented.
(1) A photonic processor for calculating a second-order Hamiltonian H⁽²⁾(u|M) with a matrix M and an input vector u, the photonic processor comprising: an array of inputs to receive a first array of optical signals modulated to encode the input vector u; an optical matrix multiplication unit, in optical communication with the array of inputs, to generate a second array of optical signals from the first array of optical signals, the second array of optical signals representing a product Mu of the input vector u and the matrix M; and an array of photodetectors, in optical communication with the optical matrix multiplication unit, to detect interference between the second array of optical signals and a third array of optical signals modulated to encode the input vector u, the interference representing the second-order Hamiltonian H⁽²⁾(u|M).
(2) The photonic processor of configuration (1), further comprising a summing circuit coupled to the array of photodetectors to sum electrical outputs from the array of photodetectors to produce a value representative of the second-order Hamiltonian H⁽²⁾(u|M).
(3) The photonic processor of configuration (2), wherein the summing circuit is further configured to subtract a reference signal from the sum of electrical outputs from the array of photodetectors such that the value representative of the second-order Hamiltonian is directly proportional to the second-order Hamiltonian.
(4) The photonic processor of configuration (2) or (3), further comprising:
   an array of probabilistic bit generators, in optical communication with the array of input optical paths, to generate each optical signal of the first array of optical signals as a value of either 1 with a controllable probability p or as a value of 0 with a controllable probability 1−p.
(5) The photonic processor of configuration (4), further comprising a feedback channel to feedback the value representative of the second-order Hamiltonian to at least one probabilistic bit generator in the array of probabilistic bit generators.
(6) A higher-order photonic processor to calculate k-order polynomial functions where k is greater than 2, the higher-order photonic processor comprising: the photonic processor as in any one of configurations (2) through (5), wherein the photonic processor is a first photonic processor; at least one second photonic processor as in any one of configurations (2) through (5) arranged in parallel with the first photonic processor; and a multiplying and summing circuit to multiply outputs from the first photonic processor and the at least one second photonic processor with components of the input vector u to produce multiplication products and to sum the multiplication products together.
(7) The photonic processor of any one of configurations (1) through (6), wherein the matrix M is non-unitary.
(8) The photonic processor of any one of configurations (1) through (7), wherein the input vector u is complex.
(9) The photonic processor of any one of configurations (1) through (8), wherein the optical matrix multiplication unit comprises an optical network having an array of Mach-Zehnder interferometers.
(10) The photonic processor of any one of configurations (1) through (9), wherein the optical matrix multiplication unit comprises a spatial light modulator.
(11) The photonic processor of any one of configurations (1) through (10), wherein the array of photodetectors is a first array of photodetectors configured to convert the interference into first electrical signals, and further comprising: a second array of photodetectors to transduce portions of the first array of optical signals representative of components of the input vector u into second electrical signals; a third array of photodetectors, in optical communication with the optical matrix multiplication unit, to transduce portions of the third array of optical signals representing the product Mu of the input vector u and the matrix M into third electrical signals; and circuitry, operably coupled to the first array of photodetectors, the second array of photodetectors, and the third array of photodetectors, to produce an output proportional to the second-order Hamiltonian H⁽²⁾(u|M) from the first electrical signals, the second electrical signals, and the third electrical signals.
(12) The photonic processor of configuration (11), wherein the matrix M is non-unitary.
(13) The photonic processor of any one of configurations (1) through (12), further comprising: a light source to generate coherent light for producing the first array of optical signals.
(14) A method of calculating a second-order Hamiltonian H⁽²⁾(u|M) with a matrix M and an input vector u, the method comprising: generating a first array of optical signals modulated to encode the input vector u; generating, with an optical matrix multiplication unit, a second array of optical signals from the first array of optical signals, the second array of optical signals representing a product Mu of the input vector u and the matrix M; and transducing interference between the second array of optical signals and a third array of optical signals modulated to encode the input vector u into an electrical signal, the interference representing the second-order Hamiltonian H⁽²⁾(u|M).
(15) The method of (14), wherein the matrix M is non-unitary and the input vector u is complex.
(16) The method of (14) or (15), further comprising: determining a reference signal proportional to a sum of |u|² and |Mu|²; and subtracting the reference signal from the electrical signal to yield an output proportional to H⁽²⁾(u|M).
(17) The method of any one of (14) through (16), further comprising decomposing a k-order Hamilton into a plurality of second-order Hamiltonians, the plurality of second-order Hamiltonians including the second-order Hamiltonian H⁽²⁾(u|M), where k is an integer greater than 2.
(18) The method of any one of (14) through (17), wherein generating the first array of optical signals comprises generating the first array of optical signals as 1's with a controllable probability p and as 0's with a controllable probability 1−p.
(19) A photonic processor for calculating a second-order Hamiltonian H⁽²⁾(u|M) with a matrix M and an input vector u, the photonic processor comprising: an array of input optical paths to receive a first array of optical signals; optical modulators coupled to the input optical paths to modulate the first array of optical signals and form a second array of optical signals representative of components of the input vector u; an optical matrix multiplication unit, in optical communication with the array of input optical paths, to generate a third array of optical signals from the first array of optical signals, the third array of optical signals representing a vector-matrix product Mu of the input vector u and the matrix M; an array of optical splitters to couple portions of the second array of optical signals onto an array of feedforward optical paths; an array of optical combiners to interfere the portions of the second array of optical signals from the feedforward optical paths with the third array of optical signals from the optical matrix multiplication unit; an array of photodetectors, in optical communication with the optical matrix multiplication unit, to detect the interference between the third array of optical signals and the portions of the second array of optical signals; and a summing circuit coupled to the array of photodetectors to sum electrical outputs from the array of photodetectors to produce a value representative of the second-order Hamiltonian H⁽²⁾(u|M).
(20) The photonic processor of configuration (19), wherein: the array of input optical paths comprise a first array of integrated optical waveguides formed on a semiconductor substrate; the optical matrix multiplication unit comprises an array of integrated Mach-Zehnder interferometers formed on the semiconductor substrate and are optically coupled to the input optical paths; and the array of feedforward optical paths comprises a second array of integrated optical waveguides formed on the semiconductor substrate and are optically coupled to the input optical paths.

### 7. Conclusion

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A photonic processor for calculating a second-order Hamiltonian H⁽²⁾(u|M) with a matrix M and an input vector u, the photonic processor comprising:
an array of inputs to receive a first array of optical signals modulated to encode the input vector u;
an optical matrix multiplication unit, in optical communication with the array of inputs, to generate a second array of optical signals from the first array of optical signals, the second array of optical signals representing a product Mu of the input vector u and the matrix M; and
an array of photodetectors, in optical communication with the optical matrix multiplication unit, to detect interference between the second array of optical signals and a third array of optical signals modulated to encode the input vector u, the interference representing the second-order Hamiltonian H⁽²⁾(u|M).

2. The photonic processor of claim 1, further comprising a summing circuit coupled to the array of photodetectors to sum electrical outputs from the array of photodetectors to produce a value representative of the second-order Hamiltonian H⁽²⁾(u|M).

3. The photonic processor of claim 2, wherein the summing circuit is further configured to subtract a reference signal from the sum of electrical outputs from the array of photodetectors such that the value representative of the second-order Hamiltonian is directly proportional to the second-order Hamiltonian.

4. The photonic processor of claim 2, further comprising:
an array of probabilistic bit generators, in optical communication with the array of input optical paths, to generate each optical signal of the first array of optical signals as a value of either 1 with a controllable probability p or as a value of 0 with a controllable probability 1−p.

5. The photonic processor of claim 4, further comprising a feedback channel to feedback the value representative of the second-order Hamiltonian to at least one probabilistic bit generator in the array of probabilistic bit generators.

6. A higher-order photonic processor to calculate k-order polynomial functions where k is greater than 2, the higher-order photonic processor comprising:
the photonic processor as claimed in claim 2, wherein the photonic processor is a first photonic processor;
at least one second photonic processor as claimed in claim 2 arranged in parallel with the first photonic processor; and
a multiplying and summing circuit to multiply outputs from the first photonic processor and the at least one second photonic processor with components of the input vector u to produce multiplication products and to sum the multiplication products together.

7. The photonic processor of claim 1, wherein the matrix M is non-unitary.

8. The photonic processor of claim 1, wherein the input vector u is complex.

9. The photonic processor of claim 1, wherein the optical matrix multiplication unit comprises an optical network having an array of Mach-Zehnder interferometers.

10. The photonic processor of claim 1, wherein the optical matrix multiplication unit comprises a spatial light modulator.

11. The photonic processor of claim 1, wherein the array of photodetectors is a first array of photodetectors configured to convert the interference into first electrical signals, and further comprising:
a second array of photodetectors to transduce portions of the first array of optical signals representative of components of the input vector u into second electrical signals;
a third array of photodetectors, in optical communication with the optical matrix multiplication unit, to transduce portions of the third array of optical signals representing the product Mu of the input vector u and the matrix M into third electrical signals; and
circuitry, operably coupled to the first array of photodetectors, the second array of photodetectors, and the third array of photodetectors, to produce an output proportional to the second-order Hamiltonian H⁽²⁾(u|M) from the first electrical signals, the second electrical signals, and the third electrical signals.

12. The photonic processor of claim 11, wherein the matrix M is non-unitary.

13. The photonic processor of claim 1, further comprising:
a light source to generate coherent light for producing the first array of optical signals.

14. A method of calculating a second-order Hamiltonian H⁽²⁾(u|M) with a matrix M and an input vector u, the method comprising:
generating a first array of optical signals modulated to encode the input vector u;
generating, with an optical matrix multiplication unit, a second array of optical signals from the first array of optical signals, the second array of optical signals representing a product Mu of the input vector u and the matrix M; and
transducing interference between the second array of optical signals and a third array of optical signals modulated to encode the input vector u into an electrical signal, the interference representing the second-order Hamiltonian H⁽²⁾(u|M).

15. The method of claim 14, wherein the matrix M is non-unitary and the input vector u is complex.

16. The method of claim 14, further comprising:
determining a reference signal proportional to a sum of |u|² and |Mu|²; and
subtracting the reference signal from the electrical signal to yield an output proportional to H⁽²⁾(u|M).

17. The method of claim 14, further comprising:
decomposing a k-order Hamilton into a plurality of second-order Hamiltonians, the plurality of second-order Hamiltonians including the second-order Hamiltonian H⁽²⁾(u|M), where k is an integer greater than 2.

18. The method of claim 14, wherein generating the first array of optical signals comprises generating the first array of optical signals as 1's with a controllable probability p and as 0's with a controllable probability 1−p.

19. A photonic processor for calculating a second-order Hamiltonian H⁽²⁾(u|M) with a matrix M and an input vector u, the photonic processor comprising:
an array of input optical paths to receive a first array of optical signals;
optical modulators coupled to the input optical paths to modulate the first array of optical signals and form a second array of optical signals representative of components of the input vector u;
an optical matrix multiplication unit, in optical communication with the array of input optical paths, to generate a third array of optical signals from the first array of optical signals, the third array of optical signals representing a vector-matrix product Mu of the input vector u and the matrix M;
an array of optical splitters to couple portions of the second array of optical signals onto an array of feedforward optical paths;
an array of optical combiners to interfere the portions of the second array of optical signals from the feedforward optical paths with the third array of optical signals from the optical matrix multiplication unit;
an array of photodetectors, in optical communication with the optical matrix multiplication unit, to detect the interference between the third array of optical signals and the portions of the second array of optical signals; and
a summing circuit coupled to the array of photodetectors to sum electrical outputs from the array of photodetectors to produce a value representative of the second-order Hamiltonian H⁽²⁾(u|M).

20. The photonic processor of claim 19, wherein:
the array of input optical paths comprise a first array of integrated optical waveguides formed on a semiconductor substrate;
the optical matrix multiplication unit comprises an array of integrated Mach-Zehnder interferometers formed on the semiconductor substrate and are optically coupled to the input optical paths; and
the array of feedforward optical paths comprises a second array of integrated optical waveguides formed on the semiconductor substrate and are optically coupled to the input optical paths.
